(19) United States
(12) Patent Application Publication
(10) Pub. No.: US 2026/0142608 A1
(43) Pub. Date: May 21, 2026

(54) GRIPPING HEAD FOR A PRE-ASSEMBLED ARRAY OF PHOTOVOLTAIC PANELS AND METHOD OF INSTALLATION OF SAID PRE-ASSEMBLED ARRAY

(71) Applicant: Enel Green Power S.p.A., Roma (RM) (IT)

(72) Inventors: Iacopo MAZZANTINI, Roma (RM) (IT); Francesco BELLAGAMBA, Roma (RM) (IT); Sebastiano MONITTO, Roma (RM) (IT)

(21) Appl. No.: 19/121,039

(22) PCT Filed: Oct. 12, 2023
(86) PCT No.: PCT/IB2023/060280

§ 371 Date: Apr. 14, 2025

(30) Foreign Application Priority Data
Oct. 14, 2022 (IT) 102022000021207

(51) Int. Cl. H02S 20/32

(52) U.S. Cl. CPC H02S 20/32

(57) ABSTRACT

The present invention relates to the technical field of the photovoltaic plants and more particularly it relates to a gripping head for a pre-assembled array of photovoltaic panels. The present invention further relates a method of installation of a pre-assembled array of photovoltaic panels. The gripping head and the method provide for a specific processing and a plurality of grippers that are optimized for the handling of the panels.

### FIELD OF THE INVENTION

The present invention relates to the technical field of the photovoltaic plants and more particularly it relates to a gripping head for a pre-assembled array of photovoltaic panels. The present invention further relates a method of installation of a pre-assembled array of photovoltaic panels.

### BACKGROUND OF THE INVENTION

As it is known, currently the methods for assembling and installing photovoltaic plants are significantly complex, expensive and require relatively long periods of time. In particular, the methods of assembly of sections of photovoltaic plants assigned to the generation of the electrical energy, also called generation sections, result to be particularly complex, expensive and time consuming.

A section of generation of a photovoltaic plant generally comprises a receiving structure which is installed firmly in fixed position on an installation ground and it further comprises a plurality of arrays of photovoltaic panels which are mounted on the receiving structure. The arrays of photovoltaic panels can be installed on the receiving structure in a fixed or mobile way. In the latter case, it is possible through suitable actuators to track the solar position in order to optimize the electrical energy generation effectiveness.

The receiving structure generally comprises one or more, for example linear, arrays of supporting poles which have to be driven into the ground. These poles have a length generally comprised between 3 m and 5 m and in order to drive them into the ground special machines are used, called pole drivers, therethrough the poles actually are hammered into the installation ground.

After the installation of the supporting poles, generally the following installation steps are performed:
Mounting pole heads on the supporting poles;
Mounting a saddle on each pole head;
Mounting possible actuators allowing to rotate the saddles around a generally horizontal rotation axis;
Mounting supporting frames of the arrays of photovoltaic panels on the saddles;
Fastening of the photovoltaic panels on the supporting frames.

The supporting frames generally comprise a main arm, also called torque tube, and a plurality of secondary arms, also called omega, which are fastened transversally to the main arm and which for example are provided with insertion profiles in order to insert slidingly each photovoltaic panel between two consecutive secondary arms.

The supporting frames of the photovoltaic panels can be assembled on the ground and then lifted with the help of cranes or telescopic forklifts in order to be fastened to the saddles. Due to the suspended loads, these activities are particularly dangerous. Alternatively, the supporting frames can be assembled directly at altitude firstly by fixing the main arm on the saddles and then by fixing the secondary arms to the main arm. These activities are particularly laborious since the fastening of the secondary arms has to be performed at altitude and the assembly precision, required by the circumstances, has to be maintained.

As it can be easily deduced, all above-described assembly and installation activities require very many hours-man and a sequence of monotone and repetitive manual procedures. The cost of such activities is particularly high. Moreover, since very often the big photovoltaic plants are installed in desert areas, the operators responsible for the installation are forced to work in open field for several days under hostile environmental and climatic conditions.

Additionally, such repetitive activity proceeds in not optimum discontinuous way by providing inactive steps of simple shifting, wherein the staff and equipment arrive at a site of interest, and activity steps, wherein the installation of the supporting frames on the saddles is actually implemented.

For the purpose of solving at least partially the above-mentioned problems of known art, photovoltaic systems and methods of installation of the same have been developed, which provide to pre-assemble the arrays of photovoltaic panels and to lift and move the pre-assembled arrays to mount them on the receiving structures installed in the site intended to house the photovoltaic plant.

U.S. Pat. No. 9,708,139 B2 describes a method of installation of a photovoltaic plant wherein the arrays of photovoltaic panels are pre-assembled at the factory and deposited in a container through a factory crane. The factory crane is provided with a vacuum gripping device comprising a plurality of suckers which grip the panels' faces. The containers of the pre-assembled arrays of photovoltaic panels are then transported on the field by a heavy vehicle comprising a dedicated crane, provided too with a vacuum gripping device comprising a plurality of suckers. The field crane collects the pre-assembled arrays and positions them on the supporting poles of the receiving structure.

WO 2021/229387 A2 describes a method of the assembly and installation of arrays of photovoltaic panels in an installation site, which comprises a first step of assembling an array of photovoltaic panels. This first assembly step is performed with the help of at least a robot in a transportable station, placed adjacent to the installation site, as “temporary factory”. The method described in this patent publication includes a second step of transporting the pre-assembled array of photovoltaic panels, wherein the pre-assembled array of photovoltaic panels is transported by the transportable station to the installation site with the help of a motorized carriage controlled by an operator outside the motorized carriage. At last, the described method comprises a third step wherein the array of photovoltaic panels is mounted on receiving structures arranged previously on the installation field.

WO 2022/112921 A2 describes a motorized carriage provided with a pantograph lifter which is capable of collecting a pre-assembled array of photovoltaic panels, transporting it near the receiving structure thereon the pre-assembled array has to be fastened. The motorized carriage allows to position the pre-assembled array with respect to the receiving structure. The pantograph lifter allows to collect the pre-assembled array of photovoltaic panels by grasping it from below by the longitudinal beam (torque tube).

Other known lifting apparatus that represent a generic technical background to the present invention are disclose by documents U.S. Pat. No. 9,908,763 and JPH08385.

The object of the present invention is to propose a solution allowing to solve, or at least to reduce partially, the drawbacks described above with reference to the known art.

### SUMMARY OF THE INVENTION

This and other objects are achieved through a gripping head for lifting and transporting a pre-assembled array of photovoltaic panels as defined in claim 1 in its most general form and as defined in the claims depending therefrom in some particular embodiments. The present invention also relates to a method of installation as defined in claim 23.

### BRIEF DESCRIPTION OF THE DRAWINGS

The invention will be better comprised from the following detailed description of embodiments thereof, provided by way of example and then in no way for limitative purposes in relation to the enclosed drawings, wherein:

FIG. 1 shows a top isometric view of a possible exemplifying and not limiting embodiment of a pre-assembled array of photovoltaic panels;

FIG. 2 shows a bottom isometric view of the pre-assembled array of photovoltaic panels of FIG. 1;

FIG. 3 shows a side view of an upper end portion of a supporting pole whereon a pole head, a saddle and an actuator are mounted;

FIG. 4 shows an isometric view of an embodiment of an assembly template to assemble arrays of photovoltaic panels;

FIG. 5 shows a side view of a first example of motorized vehicle for lifting and transporting loads having a gripping head;

FIG. 6 shows a side view of a second example of motorized vehicle for lifting and transporting loads having a gripping head;

FIG. 7 shows a first isometric view of the gripping head of FIGS. 5 and 6;

FIG. 8 shows a second isometric view of the gripping head of FIGS. 5 and 6;

FIG. 8A shows again in an isometric view and in isolation an articulated joint of the gripping head, in the region of a second motion stage;

FIG. 9 shows a third isometric view of the gripping head of FIGS. 5 and 6;

FIG. 10 shows a bottom isometric view of the pre-assembled array of FIG. 1, of the assembly template of FIG. 4 and of the gripping head of FIGS. 7, 8 and 9;

FIG. 11 shows a flow diagram of a method of installation of an array of photovoltaic panels; and

FIGS. 12A and 12B show again in a isometric view some examples of grippers of the gripping head, according to respective different embodiments.

### DETAILED DESCRIPTION OF THE INVENTION

In the enclosed figures, equal or similar elements have been designated by the same numeral references.

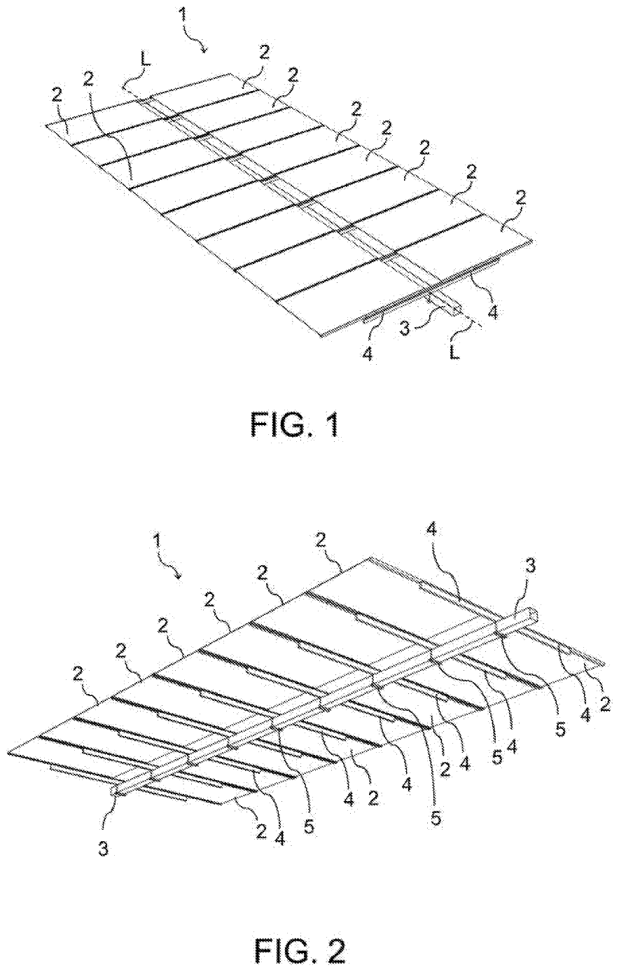

A not limiting embodiment of a pre-assembled array 1 of photovoltaic panels 2 has been schematically represented in FIGS. 1 and 2. Apart from comprising a plurality of photovoltaic panels 2, the pre-assembled array 1 further comprises a supporting structure 3, 4 of the plurality of photovoltaic panels 2. In a way known on itself, the photovoltaic panels 2 are fastened to the supporting structure 3, 4.

The pre-assembled array 1 can have considerable sizes and weights. For example, the pre-assembled array can have a length of 12 meters and a width of 5 meters and it can have a weight higher than 1,000 kg, for example equal to 1, 300 kg.

The supporting structure 3, 4, which actually is a supporting frame, comprises a main arm 3, also designated torque tube or longitudinal beam, and a plurality of secondary arms 4 mechanically coupled to the main arm 3 and which are transversal, for example perpendicular, to a direction of prevailing longitudinal extension L-L of the main arm 3. The secondary arms 4 are also designated omega.

The main arm 3 and the plurality of secondary arms 4 are preferably made of metallic material, for example iron or aluminium. The secondary arms 4 are called secondary with respect to the main arm 3 since they have a lower length with respect to that of the main arm 3 and since they are supported by the main arm 3.

The secondary arms 4 are fastened to the main arm 3 through mechanical coupling elements known on themselves, such as for example bolts and/or pins and/or fastening plates and/or fastening stirrups. Said mechanical coupling elements preferably are reversible mechanical coupling means.

For the purpose of the present description, the main arm 3 and the secondary arms 4 generally represent components of the supporting structure 3, 4 which are intended to be fastened to each other in order to assemble the supporting structure 3, 4.

According to an embodiment, the photovoltaic panels 2 are fastened to the secondary arms 4 and the secondary arms 4 are fastened to the main arm 3. In this way, the main arm 3 supports the photovoltaic panels 2 through the secondary arms 4. Preferably, the secondary arms 4 are shaped arms inside thereof coupling or insertion profiles are defined which receive edge portions of the photovoltaic panels 2.

In the particular example represented in the figures, without introducing any limitation for this, the pre-assembled array 1 of photovoltaic panels 2 is a bi-dimensional array having sixteen photovoltaic panels 2 arranged on two rows of eight photovoltaic panels 2. In order to support the above-mentioned pre-assembled array 1, the supporting structure 3, 4 has nine secondary arms 4 fastened to the main arm 3. It is clear that it is a mere example, since the number of the photovoltaic panels 2 inside a pre-assembled array 1 can be different from sixteen and for example be lower than sixteen or higher than sixteen. Moreover, the pre-assembled array 1 of photovoltaic panels 2 alternatively can be a linear array, that is an array consisting of one single row of photovoltaic panels 2. It is further to be observed that the orientation of the photovoltaic panels 2 in the pre-assembled array 1 can be both a portrait orientation and a landscape orientation.

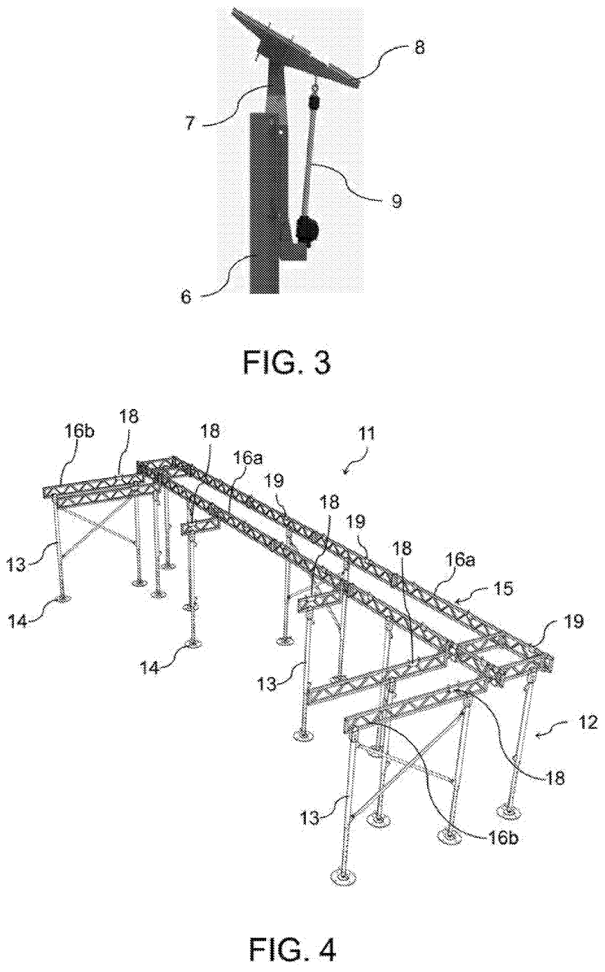

FIG. 3 shows a side view of a supporting pole 6, thereto a pole head 7, a saddle 8 and an actuator 9 are mechanically coupled. The actuator 9 is configured to be electronically controlled to rotate the saddle 8 around a rotation axis, for example a horizontal rotation axis. In an embodiment variant, the actuator 9 is not provided and in this case the arrays 1 of photovoltaic panels 2 during the operation of the photovoltaic plant are fixed and then they cannot rotate. In the installation procedures, the pole head 7, the saddle 8 and the possible actuator 9 are mechanically coupled to the supporting pole 6 after having driven the supporting pole 6 into the installation ground.

A plurality of supporting poles 6, for example aligned along a given alignment direction, constitutes a receiving structure thereto a plurality of pre-assembled arrays 1 of photovoltaic panels 2 can be fastened. For this reason, in the present description the same reference number 6 will be used both to designate the supporting poles and to designate the receiving structure.

Preferably, a pre-assembled array 1 of photovoltaic panels 2 is fastened to a plurality of saddles 8, for example to two or more saddles 8. To this purpose, for example, the main arm 3 of the supporting structure 3, 4 of a pre-assembled array 1 of photovoltaic panels 2 is fastened to two or more saddles 8, for example to two or three saddles 8 adjacent two by two.

FIG. 4 schematically shows a not limiting embodiment of an assembly template 11 adapted and configured to allow to assemble, and even to support temporarily after assembly, an array 1 of photovoltaic panels 2. In other words, the assembly template 11 allows to form a pre-assembled array 1 of photovoltaic panels 2 and to support it during assembly and before its installation on the receiving structure 6.

The assembly template 11 comprises a base structure 12, for example comprising a plurality of supporting uprights 13, for example a plurality of supporting legs 13 provided with respective resting feet 14. According to an advantageous embodiment, the supporting legs 13 are legs with variable length, for example telescopic legs.

The assembly template 11 further comprises a positioning structure 15 which is mounted above the base structure 12.

The positioning structure 15 preferably comprises a plurality of positioning crossbeams 16a, 16b. The positioning structure 15 is adapted and configured to support the main arm 3 and the secondary arms 4 during assembly of the supporting structure 3, 4. The positioning crossbeams 16a, 16b preferably are lattice crossbeams. According to a particularly advantageous embodiment, the plurality of positioning crossbeams 16a, 16b define a positioning rack.

According to an advantageous embodiment, the plurality of the positioning crossbeams 16a, 16b comprise at least a main crossbeam 16a, with relatively higher length, and a plurality of secondary crossbeams 16b, with relatively lower length, fastened to the main crossbeam 16a. The secondary crossbeams 16b are fastened transversely, preferably perpendicularly, with respect to the main crossbeam 16a. The secondary crossbeams 16b are conveniently arranged at a lower height than the at least a main crossbeam 16a.

According to a particularly advantageous embodiment, the secondary crossbeams 16b are configured to support the main arm 3 during assembly of the supporting structure 3, 4 of the pre-assembled array 1 of photovoltaic panels 2.

The positioning structure 15 comprises first alignment elements 18 to position the main arm 3 with respect to the positioning structure 15 and it further comprises second alignment elements 19 to position the secondary arms 4 with respect to the main arm 3 and with respect to the positioning structure 15. Conveniently, the first alignment elements 18 and/or the second alignment elements 19 are fastened to the positioning crossbeams 16a, 16b. For example, the first alignment elements 18 and/or the second alignment elements 19 comprise gage blocks shaped like U or L or C fastened to the positioning crossbeams 16a, 16b. Advantageously, the first alignment elements 18 and/or the second alignment elements 19 are fastened to the positioning crossbeams 16a, 16b so as to be able to adjust the fastening position with respect to the positioning crossbeams 16a, 16b.

According to an advantageous embodiment, the first alignment elements 18 are fastened to the secondary crossbeams 16b and the second alignment elements 19 are fastened to the at least a main crossbeam 16a.

Advantageously, the first alignment elements 18 and the second alignment elements 19 are configured to allow to rest thereupon the main arm 3 and the secondary arms 4 of a supporting structure 3, 4, respectively. In particular, during assembly of the supporting structure 3, 4 a first step is provided in which the main arm 3 is rested upon the first alignment elements 18 and a second step in which the secondary arms 4 are rested upon the second alignment means 19 and on the main arm 3. Once rested the main arm 3 and once rested one or more secondary arms 4, it is possible to proceed with assembling the supporting structure by fastening the secondary arms 4 to the main arm 3, for example by acting from the bottom. All above-described procedures to assemble the supporting structure 3, 4 can be performed by a worker and/or by a robot and/or by manipulators, for example compressed-air manipulators, and/or by making use of systems for supporting manpower.

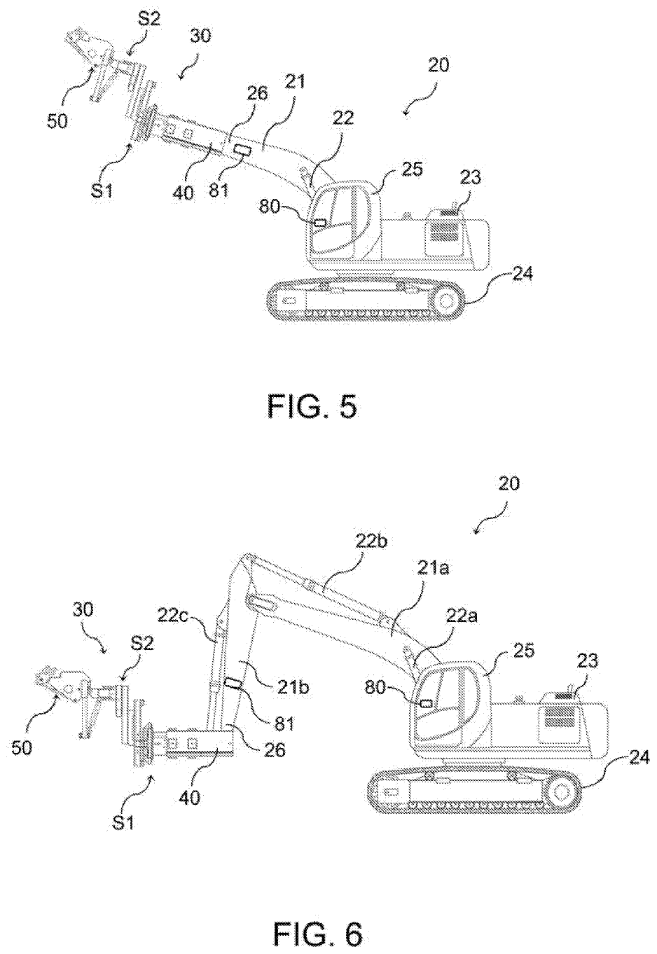

By making now reference to FIG. 5, it shows a first example of motorized vehicle 20 comprising a lifting and transportation arm 21, for example a mechanical arm movable with respect to the motorized vehicle 20. According to an advantageous embodiment, the lifting and transportation arm 21 is a telescopic arm. Additionally or alternatively, the lifting and transportation arm 21 is operatively connected to a hydraulic or pneumatic or hydro-pneumatic piston 22, configured to control the rotation of the lifting and transportation arm 21.

In the particular example represented in FIG. 5, the motorized vehicle 20 comprises a traction motor 23 adapted to provide propulsive force to tracks 24 of the motorized vehicle 20. Alternatively to tracks 24, the motorized vehicle 20 could comprise a plurality of wheels, comprising at least a steering wheel, preferably at least a pair of steering wheels. Moreover, it is to be noted that in the particular example represented in FIG. 5, the motorized vehicle 20 is provided with a driving cab 25 even if in possible embodiments the motorized vehicle 20 could be a self-driving vehicle. The motorized vehicle 20 conveniently is an off-road vehicle.

A gripping head 30 is fastened to a free end portion 26 of the lifting and transportation arm 21, which head can be controlled to grasp and release a pre-assembled array 1 of photovoltaic panels 2. The gripping head 30 can be controlled even to transport the pre-assembled array 1 near the receiving structure 6 and to position it with respect to the receiving structure 6. In fact, after having grasped a pre-assembled array 1 of photovoltaic panels 2, the gripping head 30 is configured to transport it near the receiving structure 6 and to position it with respect to the receiving structure 6 to allow to fix the pre-assembled array 1 to the receiving structure 6, that is to mount it on the receiving structure 6. After positioning and/or fastening the pre-assembled array 1 on the receiving structure 6, the gripping head 30 can be controlled to release the pre-assembled array 1.

By making now reference to FIG. 6, it shows a second example of motorized vehicle 20 comprising a lifting and transportation arm 21a, 21b which differs from the motorized vehicle 20 of FIG. 5 for the fact that the lifting and transportation arm 21a, 21b has a first arm portion 21a and a second arm portion 21b revolvingly hinged to each other. In other words, such arm 21a, 21b is an articulated arm. The gripping head 30 is fastened to an end portion 26 of the second arm portion 21b. The first arm portion 21a and the second arm portion 21b are moved respectively by two hydraulic or pneumatic or hydro-pneumatic pistons 22a and 22b. The gripping head 30 is revolvingly constrained to the second arm portion 21b to be rotated with respect to the second arm portion 21b, for example through an additional hydraulic or pneumatic or hydro-pneumatic piston 22c.

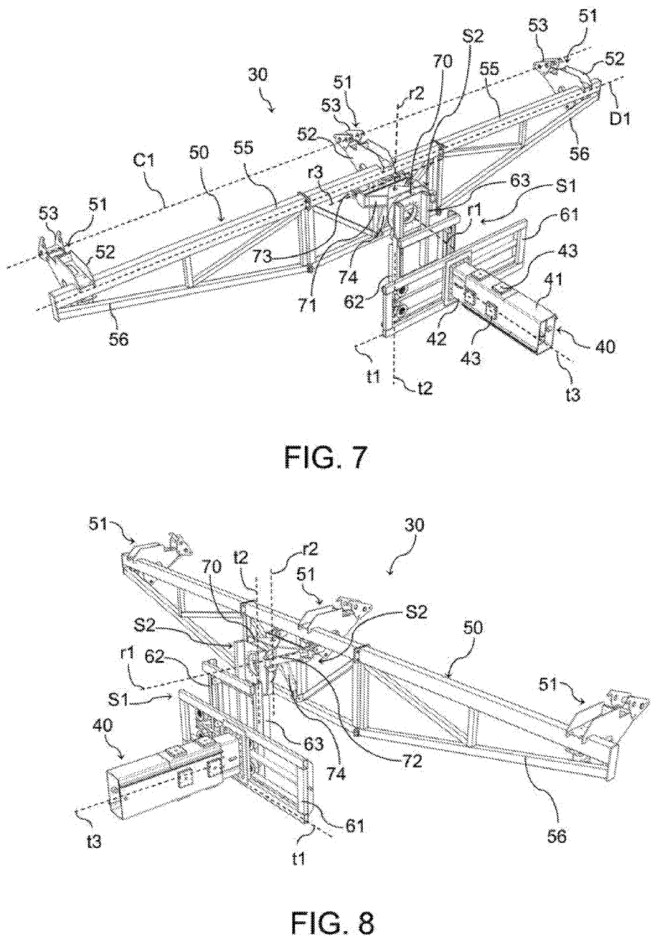

By making now reference to FIGS. 7-9, the gripping head 30 comprises a connection portion 40 and a gripping portion 50 constrained to the connection portion 40.

The connection portion 40 is adapted and configured to couple mechanically the gripping head 30 to the lifting and transportation arm 21 of a motorized vehicle 20. In the particular not limiting example represented in the enclosed figures, the connection portion 40 comprises a tubular fitting adapted to be put on the free end portion 26 of the lifting and transportation arm 21. In alternative embodiments, the connection portion 40 comprises a connection flange or a connection plate configured to be fastened to the free end portion 26 of the lifting and transportation arm 21. As already described with reference to FIG. 6, in an embodiment the connection portion 40 can be revolvingly hinged to an end portion 26 of a lifting and transportation arm 21a, 21b.

According to an advantageous embodiment, the connection portion 40 has a configurable length and for example it comprises two portions 41, 42 which are telescopically inserted into one another. For example, such portions 41, 42 comprise a relatively external tubular portion 41 and a relatively internal portion 42 sliding inside the relatively external tubular portion 41. Conveniently, the connection portion 40 comprises at least a locking element 43 allowing to lock selectively the sliding between the relatively internal portion 41 and the relatively external portion 42 once set a wished length for the connection portion 40. The locking element 43 comprises for example at least a plate provided with a hole, preferably threaded internally, which can be crossed by a locking pin, preferably threaded externally. In an embodiment variant, the length of the connection portion 40 can be controlled dynamically, for example through a linear actuator.

The gripping portion 50 comprises a plurality of grippers 51 arranged spaced apart from each other and configured to grasp the main arm 3 of the supporting structure 3, 4 of the pre-assembled array 1 of photovoltaic panels 2.

Preferably, the plurality of grippers 51 forms a linear array of grippers 51, that is a group of grippers 51 which are arranged aligned and spaced apart from each other along an alignment direction D1. In the particular not limiting example represented in the enclosed figures, the number of grippers 51 of the gripping portion 50 is equal to three. The grippers 51 can be controlled to be moved between a closing operating configuration and an opening operating configuration. In the closing operating configuration, the grippers 51 are so as to be able to grasp a pre-assembled array 1 by gripping the main arm 3 thereof. In the opening operating configuration, the grippers 51 are so as to be able to release a previously grasped pre-assembled array 1.

According to an aspect of the invention, each gripper 51 comprises a fixed jaw 52 and a mobile jaw 53. The mobile jaw 53 is revolving with respect to the fixed jaw 52, to rotate with respect to the fixed jaw 52 around a hinge axis C1. The fixed jaw 52 supports the mobile jaw 53, for example the mobile jaw 53 is revolvingly hinged to the fixed jaw 52. The rotation of the mobile jaws 53 of the grippers 51 allows to make the grippers 51 to assume the closing operating configuration or the opening operating configuration.

According to an advantageous embodiment, each gripper 51 comprises an actuator 54 (FIG. 9) controllable to rotate the mobile jaw 53 with respect to the respective fixed jaw 52. Preferably, such actuator 54 comprises a hydraulic or pneumatic or hydro-pneumatic cylinder operatively interposed between the fixed jaw 52 and the mobile jaw 53, for example having a first end portion fixed to the fixed jaw 52 and a second end portion, opposite to the first end portion, fixed to the mobile jaw 53.

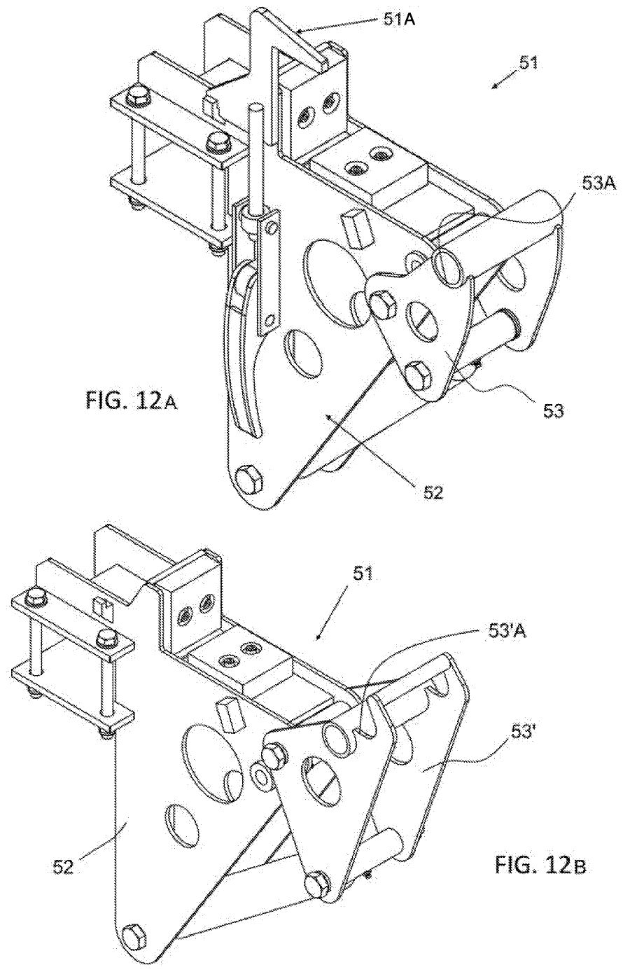

FIGS. 12A and 12B show examples of grippers according to different embodiments, in greater construction detail. In fact, the gripper 51 will have different configurations to become adaptable to the various types of supporting structures. Preferably, the gripper can comprise, as in the example of FIG. 12A, a knee-type clamp 51A to lock the supporting structure to the fixed jaw 52. The upward opening of the knee-type clamp allows the entry and exit of the supporting structure, vice versa the downward motion will tend to constrain the supporting structure to the fixed portion 52.

The comparison between FIG. 12A and FIG. 12B makes then clear different shapes of the mobile jaw, in fact indicated differently as 53 and 53′ in the two variants or versions, that can even be made available in an interchangeable way. In the version of FIG. 12A the mobile jaw 53 has a simple C-shaped seat 53A at a tip portion, to become interfaced with a structure having secondary arms hung to the main arm, whereas in the version of FIG. 12B a mobile jaw 53′ has a seat 53′A with a more elaborated, W-shaped outline formed at a lateral portion, adapted to structures with secondary arms resting on the main arm. In this second version the gripper does not need a locking device as the clamp 51A, because the jaw is capable to hold the main arm, preventing its motion along the vertical axis.

The gripping head 50 comprises a gripping arm 55 whereon the plurality of grippers 51 is fastened. Preferably, the fastening position of each one of the grippers 51 on the gripping arm 55 is adjustable.

According to an embodiment, the gripping arm 55 is a gripping rod 55 and the gripping head 50 comprises a reinforcement structure 56 fastened to the gripping rod 55. Advantageously, the reinforcement structure 56 is a lattice structure. Conveniently, the reinforcement structure 56 with respect to the gripping rod 55 is arranged on the opposite side with respect to the side whereon the jaws 52, 53 of the grippers 51 are arranged.

According to an advantageous embodiment, the set formed by the gripping rod 55 and by the reinforcement structure 56 has a generally trapezoidal shape, for example the shape of an isosceles trapezoid.

The gripping head 30 comprises a first motion stage S1, operatively interposed between the connection portion 40 and the gripping portion 50 and configured, that is adapted, to translate the gripping portion 50 along a first translation direction t1 and along a second translation direction t2 which are perpendicular to each other. It is to be noted, then, that the first motion stage S1 is configured to translate along the two translation directions t1, t2 the array of grippers 51 and in the example even the gripping arm 55.

According to an advantageous embodiment, the connection portion 40 is oriented perpendicularly with respect to the translation directions t1, t2.

According to an embodiment, the first motion stage S1 comprises a first linear guide 61 and a second linear guide 62. The first linear guide 61 supports slidingly the second linear guide 62, so that the latter could translate along the first translation axis t1. Advantageously, the first motion stage S1 further comprises a cursor 63 which is operatively coupled to the second linear guide 62 in order to slide with respect to the second linear guide 63 along the second translation axis t2. For example, the second linear guide 62 supports slidingly the cursor 63. The cursor 63 supports the gripping portion 50 of the gripping head 30.

According to an embodiment, the first motion stage S1 comprises a first linear actuator, for example a hydraulic or pneumatic or hydro-pneumatic cylinder, operatively interposed between the first linear guide 61 and the second linear guide 62 and controllable to translate the second linear guide 62 with respect to the first linear guide 61 along the first translation axis t1. Conveniently, the first motion stage S1 comprises a second linear actuator, for example a hydraulic or pneumatic or hydro-pneumatic cylinder, operatively interposed between the second linear guide 62 and the cursor 63 and controllable to translate the cursor 63 with respect to the second linear guide 62 along the second translation axis t2. Preferably, the first and the second linear actuator can be controlled independently from each other.

As already described, according to an embodiment the connection portion 40 can include two portions 41, 42 sliding therebetween. In this case, the first motion stage S1 can be adapted and configured to translate the gripping portion 50 along a third translation axis t3, which is preferably perpendicular to the first translation axis t1 and to the second translation axis t2. Such translation takes place advantageously by making the two portions 41, 42 to translate mutually to each other along the third translation axis t3.

The gripping head 30 further comprises a second motion stage S2, operatively interposed between the first motion stage S1 and the gripping portion 50 and configured, that is adapted, to rotate the gripping portion 50 with respect to the first motion stage S1 around a first rotation axis r1 and around a second rotation axis r2. The first rotation axis r1 and the second rotation axis r2 are conveniently rotation axes perpendicular to each other. It is to be noted then that the second motion stage S2 is configured to rotate around the two rotation axes r1, r2 the array di grippers 51 and in the example even the gripping arm 55.

According to an advantageous embodiment, the second motion stage S2 comprises at least a rotary motor 70 which is fastened to the first motion stage S1 and which is adapted to rotate the gripping portion 50 around the first rotation axis r1. For example, the rotary motor 70 is fastened to the cursor 63 and has a stationary portion, or stator, rigidly fastened to the cursor 63 and a rotary portion, or rotor, revolving with respect to the stationary portion. According to a particularly advantageous embodiment, the rotary motor 70 is a hydraulic motor with fifth wheel and endless screw. According to an alternative embodiment, the rotary motor 70 is an electric motor.

According to an advantageous embodiment, the second motion stage S2 comprises a first articulated joint 71, operatively interposed between the rotary motor 70 and the gripping portion 50, to allow the gripping portion 50 to be rotated around the second rotation axis r2. For example, the first articulated joint 71 comprises a first cylindrical hinge having a first stirrup fastened to the rotary motor 70, for example to the rotary portion of the rotary motor 70, and having a second stirrup revolvingly hinged to the first stirrup.

Advantageously, the second motion stage S2 comprises a third linear actuator 72 adapted to rotate the gripping portion 50 around the second rotation axis r2. For example, the third linear actuator 72 is a hydraulic or pneumatic or hydro-pneumatic cylinder. For example, the third linear actuator 72 is operatively interposed between the first stirrup 711 and the second stirrup 712 of the first articulated joint.

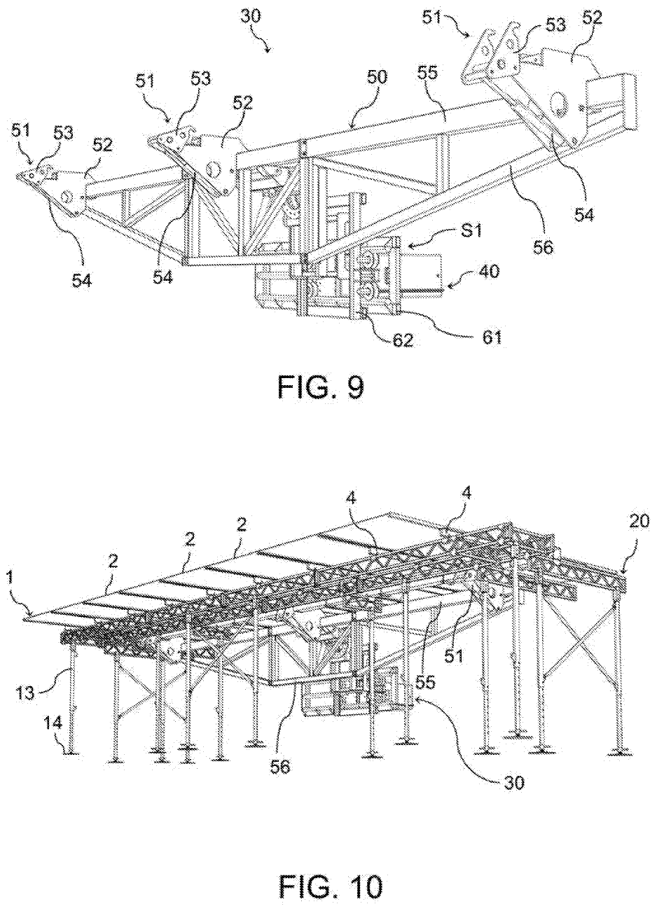

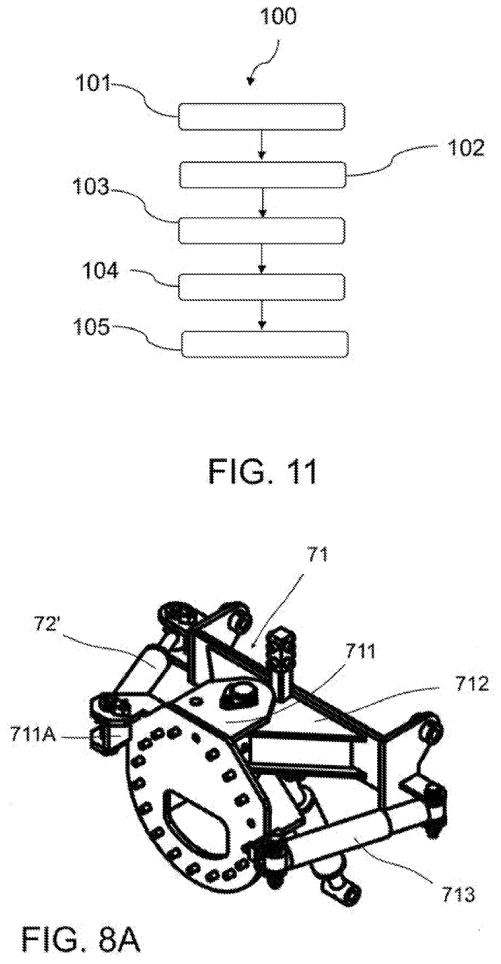

An advantageous configuration envisaged for such a motion stage is, in particular, shown in FIG. 8A. According to this design configuration, a third actuator 72′ articulates between the free end of an arm 711A projecting from the first stirrup 711, essentially in a plane orthogonal to the first axis of rotation r1, and the second stirrup 712. The pivot point spacing achieved by means of arm 711a causes the third actuator 72′ to assume an orientation closer to parallelism with respect to the first axis of rotation r1, a condition that leads it to work under a more effective loading condition that is less prone to breakage. Again, according to what can be seen in FIG. 8A, the construction of the first articulated joint 71 can be advantageously complemented by a shock absorber 713 (shown precisely only in FIG. 8A), again articulated with its ends, respectively, to the fixed stirrup 711 and the movable stirrup 712, on the opposite side from the actuator 72′. The use of the shock absorber allows dampening of oscillations during the transport route and the resulting stress peaks at the various components. It also serves to reduce the effects of pin-bush tolerances that would otherwise also lead to oscillations during travel.

According to a particularly advantageous embodiment, the second motion stage S2 is configured to rotate the gripping portion 50 with respect to the first motion stage S1 even around a third rotation axis r3. It is to be noted, then, that in such embodiment the second motion stage S2 is configured to rotate around the third rotation axis r3 the array di grippers 51 and in the example even the gripping arm 55. Preferably, the first rotation axis r1, the second rotation axis r2 and the third rotation axis r3 are rotation axes perpendicular to each other.

According to an advantageous embodiment, the second motion stage S2 comprises a second articulated joint 73, operatively interposed between the first articulated joint 71 and the gripping portion 50, to allow the gripping portion 50 to be rotated around the third rotation axis r3. For example, the second articulated joint 73 comprises a second cylindrical hinge constrained to the second stirrup of the first articulated joint 71.

Advantageously, the second motion stage S2 comprises a fourth linear actuator 74 adapted to rotate the gripping portion 50 around the third rotation axis r3. For example, the fourth linear actuator 74 is a hydraulic or pneumatic or hydro-pneumatic cylinder. For example, the fourth linear actuator 74 is operatively interposed between the second stirrup of the first articulated joint 71 and the gripping portion 50, in particular interposed between the second stirrup of the first articulated joint 71 and reinforcement structure 56.

The gripping head 30 is preferably configured to be controlled through a control system 80, 81. The control system 80, 81 is adapted and configured to control the motion of the first motion stage S1 and the motion of the second motion stage S2 of the gripping head 30. The control system 80, 81 is further adapted to control the operation of the array di grippers 51, in particular in order to make the grippers 51 to assume selectively the closing configuration and the opening configuration. The control system 80, 81 in particular allows to provide to the actuators of the gripping head 30 the electrical and/or hydraulic and/or pneumatic and/or hydro-pneumatic power required for the operation of the gripping head 30.

With reference to FIGS. 5 and 6, the electronic control system 80, 81 can include for example at least a control unit 80 and an actuation unit 81. The control unit 80 for example allows a user to control the gripping head 30 through the actuation unit 81 and for example comprises a user interface, such as for example a display interface and/or a manual control interface. The actuation unit 81 is operatively connected to the control unit 80, for example to receive therefrom one or more control signals with the purpose of driving the actuators of the gripping head 30, for example by providing to them the required electrical and/or hydraulic and/or pneumatic power. According to an embodiment, the connection between the control unit 80 and the actuation unit 81 is a wireless connection. The control unit 80 can be installed on board the motorized vehicle 20, for example in the driving cabin 25, and/or it can be a manual radio control unit which can be actuated by an operator even from outside the motorized vehicle 20.

By making now reference to FIG. 10 after having assembled an array 1 of photovoltaic panels 2 for example by using the assembly template 11 or another supporting device, the pre-assembled array 1 can be grasped by its lower face through the gripping head 30. In particular, the gripping arm 55 moved by the lifting and transportation arm 21 of a motorized vehicle 20 (for sake of illustration, the lifting and transportation arm 21 and the motorized vehicle 20 are not shown in FIG. 10), is approached to the main arm 3 of the supporting structure 3, 4 under a condition wherein the grippers 51 are in the opening operating configuration. The motion stages S1 and S2 are controlled so as to position correctly the gripping head 30 with respect to the assembly template 11 and with respect to the pre-assembled array 1. Once reached the correct positioning between the gripping portion 50 and the main arm 3, the grippers 51 are controlled to be brought in the closing operating configuration. In this way, by actuating the lifting and transportation arm 21 of the motorized vehicle 20 it is possible to collect the pre-assembled array 1 from the assembly template 11 and to transport it near the receiving structure 6 thereto the pre-assembled array 1 has to be fastened. Once reached the receiving structure 6, the lifting and transportation arm 21 and the motion stages S1 and S2 are controlled so as to position correctly the pre-assembled array 1 on the receiving structure 6. In this way, then, it is possible to proceed with the installation of the pre-assembled array 1 on the receiving structure 6 and the gripping head 30 is controlled so as to bring the grippers 51 in the opening operating configuration so that the gripping head 30 could release the pre-assembled array 1. In embodiment variant, it is possible to provide that after assembling the pre-assembled array 1 on the assembly template 11, the gripping head 30 apart from collecting the pre-assembled array 1 is so as to collect even the assembly template 11 together with the pre-assembled array 1. In this way, the pre-assembled array 1 and the assembly template 11 can be transported together near the receiving structure 6 and, once positioned with respect to the receiving structure 6, it is possible to pull out the assembly template 11.

It is to be noted that the above description also corresponds to the description of method of installation 100 to install a pre-assembled array 1 of photovoltaic panels 2 on a receiving structure 6, wherein the pre-assembled array 1 of photovoltaic panels 2 comprises a supporting structure 3, 4 thereto a plurality of photovoltaic panels 2 are fastened, wherein the supporting structure 3, 4 comprises a main arm 3 and a plurality of secondary arms 4. The method of installation 100 comprises the steps of:
collecting and transporting 102 near the receiving structure 6 the pre-assembled array 1 of photovoltaic panels 2 by means of the gripping head 30, by grasping the main arm 3 of the pre-assembled array 1 through the grippers 51 and by making the grippers 51 to assume a closing operating configuration;
positioning 103 the pre-assembled array 1 with respect to the receiving structure 6 through the gripping head 30;
releasing 104 the pre-assembled array 1 by making the grippers 51 to assume an opening operating configuration.

According to an advantageous embodiment, the method of installation 100, before the above-mentioned collecting and transporting step 102, comprises a step of assembling 101 the pre-assembled array 1 on an assembly template 11 having alignment elements 18, 19 of said main arm 3 and of said secondary arms 4.

According to a possible embodiment, in the above-mentioned collecting and transportation step 102, the pre-assembled array 1 is collected and transported through the gripping head 30 together with the assembly template 11. In this case, the method of installation 100 further comprises a step of pulling out 105 the assembly template 11 after the step of positioning 103 the pre-assembled array 1 with respect to the receiving structure 6.

Based upon what illustrated above, then, it is possible to understand that a gripping head 30 of the above-described type allows to achieve fully the above-mentioned objects with reference to the state of the known art. In fact, f the gripping head 30 allows to collect, to transport and to position pre-assembled arrays 1 of photovoltaic panels 2 in a particularly effective and precise way. The use of the gripping head 30 further allows not to request the ad hoc development of heavy vehicles or to make significant changes to heavy vehicles. The gripping head 30 can be installed on motorized vehicles 20 provided with a lifting and transportation arm 21 which are already available on the market. The gripping head can be further easily disassembled from a motorized vehicle 20 in order to be installed on another motorized vehicle and/or to be transported.

In general, grippers such as those provided according to an aspect of the invention are suitable to withstand the considerable stresses due to the weight of panel support frames and the dynamic stresses due to transportation by vehicles, and thus are of far greater effectiveness than potentially alternative systems (e.g., suction cups). The configuration of the jaws and associated actuator is, after all, capable of allowing the correct and precise sizing to grip the main tube of the structure with predetermined force and pressure so as not to damage the tube itself and to maintain a firm grip.

However, soft, shock-absorbing materials can be advantageously used in the contact areas between the support structure and the jaws to keep the grip firmly in place, even during transport, but at the same time avoid damaging the object to be transported.

The shape and positioning of the grippers allow the operator to ascertain at first glance the condition of the grippers and thus the quality of the grip.

Given the complexity of photovoltaic module structures, the grippers offer, as explained above, the possibility of customizing the design for each type of frame, this is to avoid interference with the photovoltaic modules themselves or with the secondary arms that would lead to damage to the structure being transported. A certain grip design can also be optimized to interface with the maximum number of photovoltaic module support frame configurations, also taking into account that the grippers can easily translate on the arm to accommodate different module support frame configurations.

The gripping head according to the invention may also comprise a CCTV shooting system comprising video cameras distributed along the gripping arm 55, to assist the worker in the visualization and control of the gripping operations. For example, three cameras can be made use of, two substantially at the center of a right (or left arm) of the arm, in opposition of focus, and a third camera at the center of the other half of the arm.

There can also be provided a manometer for checking the pressurization of the hydraulic, pneumatic or hydro-pneumatic circuit that controls the various components of the system, in order to verify their correct operation.

Without prejudice to the invention principle, the embodiments and the embodiment details could be widely varied with respect to what has been described and illustrated by pure way of example and not for limitative purposes, without leaving for this the scope of the invention as defined in the enclosed claims.

1. A gripping head for a pre-assembled array of photovoltaic panels, wherein the gripping head is configured to grasp and move the pre-assembled array of photovoltaic panels, wherein the pre-assembled array of photovoltaic panels comprises a supporting structure thereto a plurality of photovoltaic panels are fastened, wherein the supporting structure comprises a main arm and a plurality of secondary arms, said gripping head comprising:
a connection portion and a gripping portion constrained to the connection portion, wherein the connection portion is adapted and configured to couple mechanically the gripping head to the lifting and transportation arm of a motorized vehicle;
a first motion stage, operatively interposed between the connection portion and the gripping portion and configured to translate the gripping portion along a first translation direction and along a second translation direction which are perpendicular to each other;
a second motion stage, operatively interposed between the first motion stage and the gripping portion and configured to rotate the gripping portion with respect to the first motion stage around a first rotation axis and around a second rotation axis;
wherein said gripping portion comprises a plurality of grippers arranged spaced apart from each other and which are configured to grasp the main arm of the supporting structure of the pre-assembled array of photovoltaic panels, each of said grippers comprising a fixed jaw and a mobile jaw which is revolvingly hinged to said fixed jaw.

2. The gripping head according to claim 1, wherein the second motion stage is configured to rotate the gripping portion with respect to the first motion stage around a third rotation axis.

3. The gripping head according to claim 2, wherein the first rotation axis, the second rotation axis and the third rotation axis are rotation axes perpendicular to each other.

4. The gripping head according to claim 1, wherein the first motion stage comprises a first linear guide and a second linear guide and wherein the first linear guide supports slidingly the second linear guide, so that the latter could translate along the first translation axis, and wherein the first motion stage further comprises a cursor which is operatively coupled to the second linear guide in order to slide with respect to the second linear guide along the second translation axis.

5. (canceled)

6. The gripping head according to claim 4, wherein the first motion stage comprises:
a first linear actuator, operatively interposed between the first linear guide and the second linear guide, controllable to translate the second linear guide with respect to the first linear guide;
a second linear actuator operatively interposed between the second linear guide and the cursor, controllable to translate the cursor with respect to the second linear guide.

7. The gripping head according to claim 1, wherein the gripping head comprises a gripping arm whereon the plurality of grippers are fastened wherein the gripping arm is a gripping rod and wherein the gripping head comprises a reinforcement structure fastened to the gripping rod and wherein the reinforcement structure preferably is a lattice structure.

8. (canceled)

9. The gripping head according to claim 1, wherein the second motion stage comprises at least a rotary motor fastened to the first motion stage and adapted to rotate the gripping portion around the first rotation axis.

10. The gripping head according to claim 2, wherein the second motion stage comprises a first articulated joint, operatively interposed between the rotary motor and the gripping portion, to allow the gripping portion to be rotated around the second rotation axis.

11. The gripping head according to claim 10, wherein said first articulated joint comprises a first cylindrical hinge having a first stirrup fastened to the rotary rotor, a second stirrup revolvingly hinged to the first stirrup, and a third linear actuator operatively arranged between the first stirrup and the second stirrup.

12. The gripping head according to claim 11, wherein said third actuator is articulated between a free end of an arm projecting from the first stirrup, substantially on a plane orthogonal to the first axis of rotation, and the second stirrup, along an orientation closer to parallelism with respect to the same first axis of rotation.

13. The gripping head according to claim 12, wherein said first articulated joint further comprises a damper articulated at its ends respectively to the fixed stirrup and to the mobile stirrup, at an opposite side with respect to the third actuator.

14. The gripping head according to claim 11, wherein said second motion stage comprises a second articulated joint operatively arranged between the first articulating joint and the gripping portion, to allow the gripping portion to be rotated about the third axis of rotation, said second articulated joint comprising a second cylindrical hinge constrained to the second stirrup of the first articulated joint, and a fourth linear actuator operatively interposed between the second stirrup of the first articulated joint and the gripping portion.

15. The gripping head according to claim 1, wherein said mobile jaw comprises a C-shaped seat formed at a tip portion, adapted to become interfaced with a structure having secondary arms hung to the main armed.

16. The gripping head according to claim 15, wherein the mobile jaw of said grippers comprise a mobile jaw providing a knee-type clamp to lock the supporting structure to the fixed jaw.

17. The gripping head according to claim 1, wherein said mobile jaw comprises a W-shaped profile seat formed at a lateral portion, adapted to become interfaced with a structure having secondary arms resting on the main arm.

18. (canceled)

19. The gripping head according to claim 1, comprising a CCTV shooting system with a plurality of video cameras arrange on said gripping portion, comprising three video cameras distributed along the gripping arm, of which two cameras are substantially at the center of a half of the gripping arm, in opposition of focus, and a third camera is substantially at the center of the other half of the gripping arm.

20-21. (canceled)

22. A motorized vehicle for lifting and transporting loads having a lifting and transportation arm and a gripping head according to claim 1 wherein the gripping head is fastened through said connection portion to a free end portion of said lifting and transportation arm.

23. A method of installation to install a pre-assembled array of photovoltaic panels on a receiving structure, wherein the pre-assembled array of photovoltaic panels comprises a supporting structure thereto a plurality of photovoltaic panels are fastened, wherein the supporting structure comprises a main arm and a plurality of secondary arms, wherein the method of installation comprises the steps of:
collecting and transporting near the receiving structure the pre-assembled array by means of a gripping head according to claim 1, by grasping said main arm through said plurality of grippers and by making said plurality of grippers to assume a closing operating configuration;
positioning the pre-assembled array with respect to the receiving structure through said gripping head;
releasing the pre-assembled array by making said plurality of grippers to assume an opening operating configuration.

24. The method of installation according to claim 23, comprising before said collecting and transporting step a step of assembling the pre-assembled array on an assembly template having alignment elements of said main arm and of said secondary arms.

25. A method of installation according to claim 1, wherein in the collecting and transporting step, the pre-assembled array is collected and transported by means of said gripping head together with the assembly template and wherein the method of installation comprises a step of pulling out the assembly template after the positioning step.
